(19) United States
(12) Patent Application Publication
(10) Pub. No.: US 2008/0032165 A1
(43) Pub. Date: Feb. 7, 2008

(54) Fuel cell device, control device, control method, and control program

(75) Inventor: Atsushi Yamaguchi, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/878,594

(22) Filed: Jul. 25, 2007

(30) Foreign Application Priority Data
Jul. 25, 2006 (JP) 2006-201916

(51) Int. Cl. H01M 8/04; H01M 8/00

(52) U.S. Cl. 429/13; 429/22; 429/23

(57) ABSTRACT

The fuel cell discussed herein includes embodiments a drive load, a load switch connecting either of a steady state load and a drive load to a fuel cell, and a load adjuster adjusting a value of the drive load. w A load switch switches the load of the fuel cell to the drive load in the drive period of the fuel cell, the load adjuster increases step by step the load of the drive load. The load switch switches, when the drive load reaches a predetermined value, the load of the fuel cell to the steady state load from the drive load.

### CROSS-REFERENCE TO RELATED APPLICATIONS

This application is related to and claims the benefit of Japanese Patent Application No. 2006-201916, filed Jul. 25, 2006, the disclosure of which is incorporated herein by reference.

### BACKGROUND

1. Field of the Invention

The embodiments discussed herein relate to a fuel cell device using a liquid fuel or the like and particularly to a fuel cell device suitable as a power source of a personal computer and a mobile terminal or the like and to an apparatus, method, and program for controlling the same fuel cell device.

2. Description of the Related Art

A fuel cell can provide electrical energy from fuel through an electrochemical reaction of a fuel and oxygen in the air. Theoretical energy density of the fuel itself in a fuel cell is greater several times that of a lithium-ion cell. While it is possible that a power generating portion of a fuel cell can be reduced in size in comparison to the fuel and thereby effective reaction can also be realized, it is probably possible to attain energy density drastically exceeding a secondary cell. Attention is concentrated to a fuel cell as a power source in place of a lithium-ion secondary cell.

A fuel cell is classified, in accordance with a kind of electrolyte used, into an alkali type, phosphoric acid type, dissolved carbonate type, solid-state oxide type, and solid-state polymer type cells. A fuel cell mounted in a mobile electronic requires a structure suitable for a reduction in size and weight, to be handled easily, to be driven and stopped easily, and to be resistive to shock and vibration. The solid-state polymer type fuel cell is a total solid-state type cell using a polymer film as the electrolyte.

Moreover, the solid-state polymer type fuel cell has a simple structure, operated under a lower temperature, and driven and stopped quickly, which makes this cell suitable as a fuel cell for mobile electronic devices. Particularly, a direct methanol type fuel cell (DMFC) using methanol as the fuel is employed for a small-size mobile electronic device because of higher energy density of methanol and easier storage thereof and simplified cell structure.

A fuel cell is constituted by a structure where a polymer electrolyte film is allocated as a substance for permeating protons or electrons, a fuel electrode is allocated to one surface side of this electrolyte film, while an air electrode is allocated to the other surface side. A liquid fuel, including a hydrogen element such as a methanol aqueous solution, is supplied to the fuel electrode, and the air including an oxygen element, to the air electrode. In the electrolyte film, the hydrogen anodes are transmitted from the liquid fuel in the side of the fuel electrode and are coupled with oxygen in the air in the air electrode side. Electrons remaining in hydrogen within the liquid fuel can be extracted, with this coupling, to the external side as electricity to provide the function of a cell.

In the so-called liquid supplying type fuel cell supplying the methanol aqueous solution directly to the fuel electrode side using the polymer electrolyte film, a terminating process such as purification of an electrolyte film by water and removal of fuel by air is generally conducted to prevent contact of the polymer electrolyte film and the fuel as an operation life extending process of a fuel cell when the operations are terminated. Therefore, when drive of the fuel cell is requested again, it is required to penetrate the liquid fuel into the polymer electrolyte film.

Accordingly, if a fuel cell is used under a condition when the liquid fuel has not yet penetrated the polymer electrolyte film, the fuel cell is sometimes operated under the condition that an output of the fuel cell is low. Moreover, stable output cannot be obtained because a momentary reduction of output occurs for variation of a load. In addition, the state that a longer time is required until the necessary output can be attained from the condition that a large load is given even when the liquid fuel has not penetrated into the polymer electrolyte film is not suitable as the power source of a mobile electronic device.

Considering the background explained above, a control method of the fuel cell is required, in which a fuel cell may be operated within an adequate period of time by assuming the penetrating state of fuel into the polymer electrolyte film from a voltage value of the fuel cell. Accordingly, the following methods have been proposed in the patent documents. For example, Japanese Unexamined Patent Application Publication No. 1989-12465 discloses a method where a supply of fuel to a fuel cell is started, a drive resistor is connected with a switch when a fuel cell output voltage reaches the limited voltage, an output voltage is controlled with an inverter so that the fuel cell does not enter an over-voltage condition, and a load condition of the fuel cell is adjusted. Next, Japanese Unexamined Patent Application Publication No. 1992-267066 discloses a method where an inverter is driven after a DC output voltage of the fuel cell is established up to the value sufficient for coupling a load, and thereby the loading operation can be started smoothly.

In the methods of driving a fuel cell device of Japanese Unexamined Patent Application Publication No. 1989-12465 and No. 1992-267066 explained above, a DC output voltage value from a fuel cell body is always monitored and an inverter is driven and oscillated when such DC output voltage reaches the predetermined value to provide uniform distribution of stack voltages, and thereafter the inverter shifts to the loading operation. Here, the inverter adjusts a voltage applied to a drive load with a voltage control function thereof, and increases or decreases a loading power thereof. With the means explained above, the fuel cell voltage at the time of drive can be kept within an allowable level, and thereby continuous voltage control can be realized without giving a sudden change to the fuel cell body.

However, the method of driving such a fuel cell device has a problem in that it is impossible to realize highly effective operations to control an output of the fuel cell to the primary output by changing the load power gradually.

### SUMMARY

Considering the background explained above, an object of the embodiments is to provide a method to drive a fuel cell device, and more specifically to reduce the time required to start an operation without changing step by step a load in accordance with voltage, current, and time until an output reaches a specified output.

Moreover, another object of the embodiments is to provide an electronic apparatus having a highly reliable fuel cell device through a stable loading operation.

A fuel cell device of the embodiments comprises a drive load, a load switch connecting any of the steady state load and the drive load, and a load adjuster adjusting a value of the drive load, wherein the load switch switches, at a time of driving the fuel cell, the load thereof to the drive load, and the load adjuster increases step by step the value of said drive load, and the load switch switches, when the value of said drive load reaches a predetermined value, the load of the fuel cell to the steady state load from the drive load.

Moreover, in the load adjuster of the fuel cell device of the embodiments, an increase in the value of said drive load is restricted when an output current of the fuel cell is equal to or exceeds a specified current value.

Moreover, in the load adjuster of the fuel cell device of the embodiments, an increase in the value of said drive load is restricted when an output voltage of the fuel cell is equal to or lower than a predetermined voltage value.

Moreover, a controller of the embodiments comprises a load switch connecting any of the steady state load and a drive load to the fuel cell, and a load adjuster adjusts a value of the drive load, wherein the load switch switches, at the time of driving the fuel cell, a load thereof to the drive load, the load adjuster increases step by step the value of said drive load, and the load switch switches, when the value of said drive load reaches a predetermined value, a load of the fuel cell to the steady state load from the drive load.

A control method of a fuel cell device comprises connecting a drive load to the fuel cell at a time of driving the fuel cell, increasing step by step a value of the connected drive load, and connecting the drive load to the fuel cell from the drive load when the value of said drive load reaches a predetermined value.

Moreover, a program of the fuel cell device of the embodiments controls a computer to execute connecting a drive load to the fuel cell at a time of driving the fuel cell, increasing step by step a value of the drive load, and connecting a steady state load to the fuel cell from the drive load when the value of said drive load reaches a predetermined value.

### BRIEF DESCRIPTION OF THE DRAWINGS

FIG. 1 illustrates a fuel cell device in relation to a first embodiment.

FIG. 2 illustrates an over-voltage protecting circuit of a fuel cell device in relation to the first and a second embodiment.

FIG. 3 illustrates a load switch circuit of the fuel cell device in relation to the first and second embodiments.

FIG. 4 illustrates a drive load of the fuel cell device in relation to the first embodiment.

FIG. 5 shows a flow of operations to reach an initial state of the fuel cell.

FIG. 6 shows a flow of operations driving a fuel cell drive process when the upper limit value of voltage is varied in the present invention.

FIG. 7 is illustrates an example of load control in the drive period.

FIG. 8 illustrates the fuel cell drive process when the lower limit value of current is varied in the present invention.

FIG. 9 illustrates the fuel cell drive process when the voltage and current are varied compositely while emphasis is placed on the voltage in the present invention.

FIG. 10 illustrates the fuel cell drive process when the voltage and current are varied compositely while emphasis is placed on the current in the present invention.

FIG. 11 illustrates the fuel cell drive process when a load increase timer is provided under the condition that the voltage and current are varied compositely while emphasis is placed on the voltage in the present invention.

FIG. 12 illustrates an example of changes with time in the voltage, current and power when the present invention is applied.

FIG. 13 illustrates an output characteristic when the process of the present invention is executed or not executed.

FIG. 14 illustrates a fuel cell device of the second embodiment.

### DETAILED DESCRIPTION OF THE EMBODIMENTS

### First Embodiment

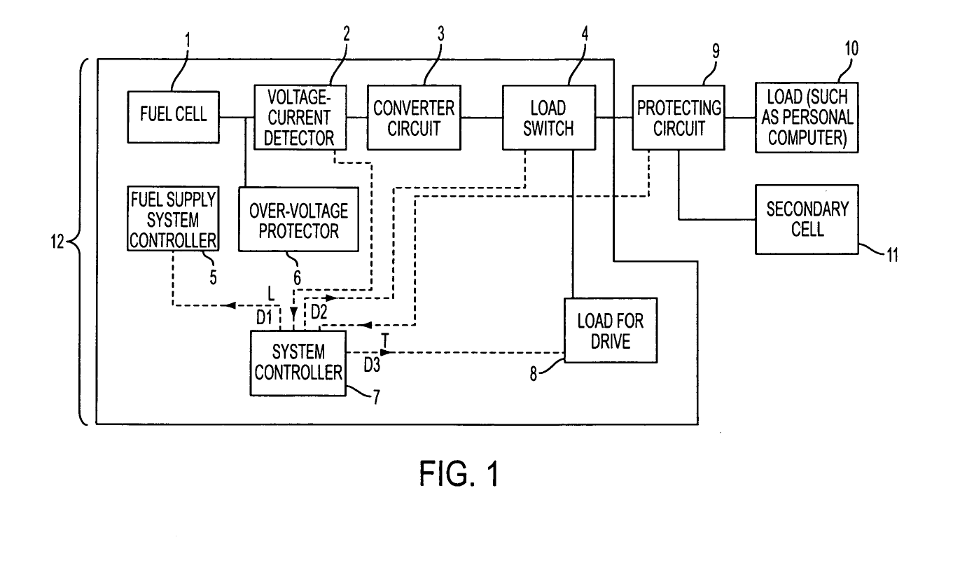

A first embodiment will be explained with reference to FIG. 1. FIG. 1 is a diagram illustrating a total system of a fuel cell device in relation to the first embodiment.

In FIG. 1, the reference numeral 1 denotes a fuel cell; 2, a voltage-current detector; 3, a converter circuit; 4, a load switch; 5, a fuel supplying system controller; 6, an over-voltage protector; 7, a system controller; 8, a drive load unit; 9, a protecting circuit; 10, a steady state load such as a personal computer; 11, a secondary cell; and 12, a fuel cell device.

The fuel cell 1 is connected to the voltage-current detector 2 detecting an output voltage and an output current, the voltage-current detector 2 is connected to the converter circuit 3, the converter 3 is connected to the load switch 4, the load switch 4 is connected to the protecting circuit 9, the protecting circuit 9 is connected to the load 10 such as a personal computer and the secondary cell 11.

Moreover, the over-voltage protector 6 is connected between the fuel cell 1 and the voltage-current detector 2 to restrict an output voltage of the fuel cell when fuel is supplied to the fuel cell 1 and an output voltage of the fuel cell 1 rises. In addition, the drive load 8 with a higher internal resistance, is connected in parallel to the load switch 4.

In the embodiment of FIG. 1, the fuel cell device 12 is provided with the fuel cell 1 to generate electrical power using the fuel. The fuel cell 1 comprises an electrolyte film, an air electrode, and a fuel electrode with the relevant air electrode and fuel electrode allocated to hold the electrolyte film. The air electrode supplies air including an oxygen element to one surface side of the electrolyte film, and the fuel electrode supplies, to the other surface side of the electrolyte film, a liquid fuel including a hydrogen element such as a methanol aqueous solution or the like as the fuel.

The electrolyte film is a permeable film formed of a substance to permeate protons or electrons and is constituted, for example, with a polymer electrolyte film such as a proton conductive solid-state polymer film formed of a substance such as purfluorosulfonic acid (Nafion™). Therefore, the electrolyte film permeates the hydrogen protons from the liquid fuel in the fuel electrode side, and the hydrogen protons are coupled with oxygen in the air supplied from the air electrode side. As a result of such coupling, electrons remaining in hydrogen within the liquid fuel are extracted as electricity and this power generating operation satisfies the function as a fuel.

When methanol is used as a liquid fuel, water (vapor) is generated in the fuel cell 1 through a reaction of hydrogen and oxygen via a proton electrolyte of the electrolyte film, and carbon dioxide bubbles are generated in the fuel electrode side by decomposition of methanol. For example, when power generation is conducted on the basis of ideal chemical changes through consumption of methanol of one mol and water of one mol in the fuel electrode side and consumption of oxygen of one mol in the air electrode side, the water of about three mol is generated in the air electrode side, while carbon dioxide of about one mol is in the fuel electrode side after such power generation.

When the fuel cell 1 is driven, the voltage-current detector 2 detecting an output voltage and an output current of the fuel cell generates a detection signal L by detecting voltage and current of the fuel cell 1. The detection signal L is inputted to the system controller 7 as control information. The system controller 7 generates drive signals D1, D2, and D3 by receiving the detection signal L. The fuel supplying system controller 5 controls a supply of fuel to the fuel cell and starts the supply of fuel to the fuel cell by receiving the drive signal D1. The load switch 4 switches a load through which the output voltage and output current of the fuel cell flows to any of the drive load unit 8 and the load 10 such as a personal computer, and switches the load by receiving the drive signal D2. A load power of the drive load unit 8 increases through voltage variation or current variation on the basis of a constant ratio, and realizes an increase in the load power of the drive load unit 8 by receiving the drive signal D3.

Moreover, the load 10, such as a personal computer, receives an influence of a voltage-drop and surge, because of a load of the fuel cell 1, such as sudden power generation and stop of operation. In order to prevent a fault in a power supply circuit and a mother board of the personal computer due to such influence, the protecting circuit 9 generates a stop signal T and this-stop signal T is applied to the system controller 7 as the control information.

The system controller 7 is constituted with a microprocessor or the like and provides operations such as execution of fuel supply, stop of fuel supply, and load control for the fuel cell 1 as explained above with regard to a control program, discussed later herein.

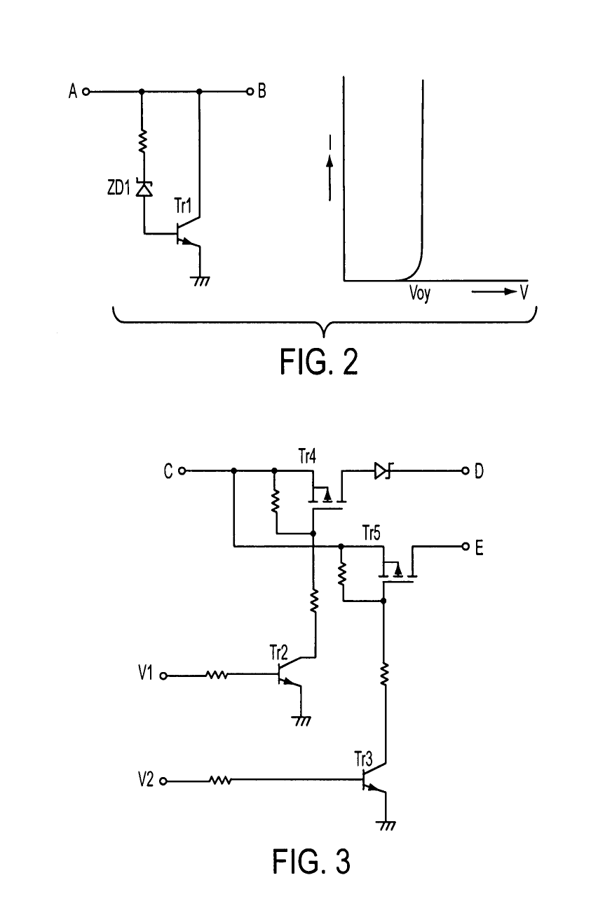

FIG. 2 illustrates an example of an over-voltage protecting circuit of the over-voltage protector 6 in this embodiment. A protection threshold voltage Vov is a sum of a zener voltage Vzd1 of a zener diode ZD1 and a forward voltage VbeTr1 between the base and emitter electrodes of a transistor Tr1. Namely, the protection threshold voltage Vov is expressed as Vov=Vzd1+Vbetr1.

The zener diode does not allow current flow when it is loaded by an inverse voltage which is lower than a setting voltage Vzd1, but allows current flow when the zener diode is loaded with an inverse voltage which is higher than the setting voltage.

A transistor has three terminals of base, emitter, and collector. The ON/OFF control of a heavier current between the collector and emitter can be realized by ON/OFF control of a lower current between the base and emitter, resulting in a switching operation.

As an example of the application of the aforementioned elements into an over-voltage protecting circuit, a circuit as illustrated in FIG. 2 is constituted.

A point A in the over-voltage protecting circuit is connected to the fuel cell 1, while the point B is connected to the voltage-current detector 2. A power line between points A and B in FIG. 2 is identical to the line between the fuel cell 1 and the voltage-current detector 2 in FIG. 1.

Operation of the over-voltage protecting circuit of the over-voltage protector 6 will be explained below.

When an input voltage Va of the fuel cell 1 is in a condition of Va<Vov, namely when an inverse voltage applied to the zener diode is lower than the setting voltage, no current flows between the base and emitter and therefore the transistor is set to the OFF state and no current flows into the over-current protecting circuit.

Meanwhile, when the input voltage Va rises exceeding Vov, a current starts to flow into the zener diode. Therefore, a base current Ib flows between the base and emitter of the transistor, setting the transistor to the ON state.

When the current Ib flows between the base and emitter, a collector current Ic flows between the collector and emitter. In the transistor, the base current Ib is multiplied by hfe times to become the collector current Ic. A proportional constant hfe is called a DC current amplifying factor and the value hfe is about 10 to 1000. Usually, the target of hfe is set to about 100 in many transistors.

Under a condition that the collector current Ic increases in comparison with the base current Ib and a large amount of collector current Ic flows as a result, an impedance of the over-voltage protecting circuit becomes almost equal to 0 and therefore an output voltage Vb can no longer rise.

With the operations of the over-voltage protecting circuit explained above, the output voltage Vb is always kept equal to Vov or lower.

FIG. 3 illustrates an example of a load switching circuit in the load switch 4 in the first embodiment of the present invention or in a load limiting circuit 14 in the second embodiment.

When the voltages V1 and V2 in FIG. 3 are set to low voltages, the current does not flow into the circuit and an output is provided from the fuel cell.

Moreover, the voltage V1 is set to a low voltage, while the voltage V2 to a high voltage, an output current of the fuel cell flows into the drive load unit 8.

Moreover, when the voltage V1 is set to a high voltage, while the voltage V2 to a low voltage, an output current of the fuel cell flows into the load 10, such as the personal computer or the secondary cell 11.

It is desirable to provide an input preventing diode to the circuit where a current flows into the load 10, such as the personal computer or secondary cell 11 to prevent an input of current to the fuel cell side. In this load switching circuit, a fuel cell output is switched to any of the drive load 8, load 10 such as the personal computer, and the secondary cell 11, to control the fuel cell device 12.

In addition, a point C of the load switching circuit is connected to receive an output of the fuel cell 1, while a point D is connected to the load 10 such as the personal computer, and a point E is connected to the drive load unit 8. The system controller 7 generates the drive signal D2 to set the voltages V1 and V2, while the load switch 4 switches the load by receiving the drive signal D2.

The power line C-D in FIG. 3 is identical to the line between the converter circuit 3 and the protecting circuit 9 in FIG. 1.

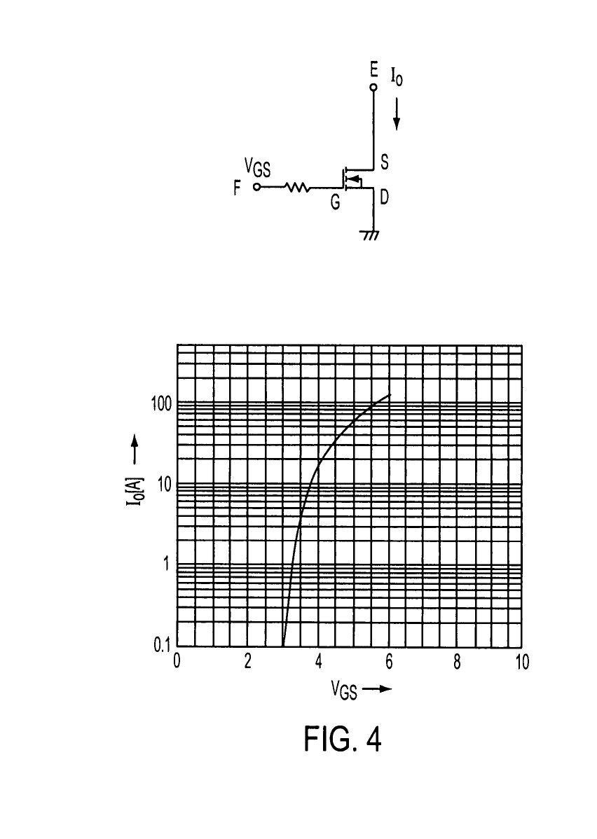

FIG. 4 illustrates an example of a load circuit in the drive load unit 8 in the first embodiment. The load circuit is constituted with a field effect transistor (FET).

The FET has three terminals and three portions constituting the FET which are respectively called the source (S), gate (G) and drain (D). When a gate voltage Vgs rises with reference to the source (S), the current Id flowing to the drain (D) from the source (S) rises drastically.

In a case where the field effect transistor (FET) is applied to the load circuit, the system controller generates the drive signal D3 and the drive load unit 8 receives the drive signal D3 to control a voltage Vgs.

Namely, when the fuel cell 1 is driven, the drive load unit 8 receives the drive signal D3 to set the voltage Vgs to a value higher than the threshold voltage value from the system controller 7. When the voltage Vgs rises, the current Id flows into the load circuit. Thereby, the voltage Vgs is increased (step by step) to also increase the current Id.

On the other hand, when the fuel cell 1 is driven and shifts to a steady state operation (normal operation), the drive load unit 8 receives the drive signal D3 from the system controller 7 to set the voltage Vgs to a value lower than the threshold voltage value. When the voltage Vgs becomes lower than the threshold voltage value, the current Id does not flow easily into the side of the drive load circuit.

In the graph of FIG. 4, the current Id is plotted on the vertical axis and the voltage Vgs on the horizontal axis, to show a typical transfer characteristic.

A point E of the load circuit is connected to the point E of the load switching circuit, while a point F of the load circuit is connected to the system controller 7. Namely, the drive signal D3 generated by the system controller 7 is connected to the point F in the load circuit.

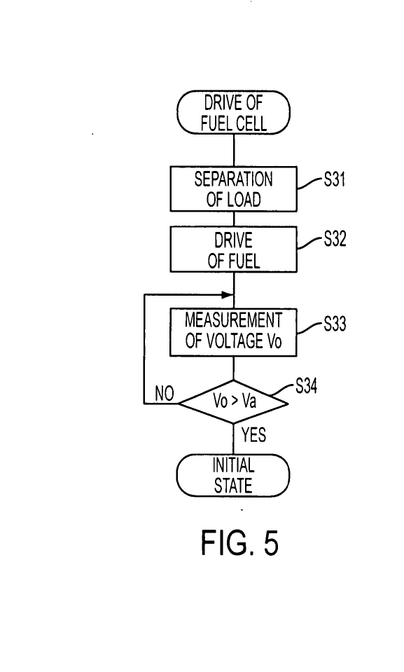

FIG. 5 illustrates a flow of operations of the system controller 7 in the system of FIG. 1 to reach the initial state of the fuel cell 1.

Next, operations of the system controller 7 in the system of FIG. 1 will be explained with reference to FIG. 5. First, upon receipt of an operating instruction, the system controller 7 corresponding to the controller generates the drive signal D2 to separate the load at the time of drive of the fuel cell 1, and the load switch 4 separates both the drive load 8 and the load 10 such as the personal computer. (Step S31)

Since the drive signal D2 sets the voltages V1, V2 of the load switching circuit (FIG. 3) to lower values, the drive load 8 and the load 10 are separated.

After both loads are separated, the system controller 7 outputs the drive signal D1 to the fuel supply system controller 5 in order to supply the fuel to the fuel cell 1, and the fuel supply system controller 5 having received the drive signal D1 which drives the fuel system to supply the fuel and oxygen to the fuel cell 1. (Step 32)

When fuel and oxygen are supplied sufficiently to the fuel cell, the fuel cell 1 performs power generation. Here, the fuel cell 1 performs the power generation under a non-loading state where any load is not connected. The voltage-current detector 2 always reads voltage and current of the fuel cell 1, while the system controller 7 receives a non-load voltage Vo of the fuel cell 1 which is read by the voltage-current detector 2. (Step 33)

The system controller 7 determines whether the non-load voltage Vo of the fuel cell 1 transmitted from the voltage-current detector 2 rises to a voltage initial value Va as the limited voltage or not. (Step S34). Namely, the controller 7 determines whether the fuel has been supplied sufficiently to the fuel cell 1 or not.

When the non-load voltage Vo of the fuel cell 1 is lower than the voltage initial value Va, the operation returns to the step S33. The system controller 7 continuously receives the non-load voltage Vo of the fuel cell 1 read by the voltage-current detector 2. Moreover, when the non-load voltage Vo of the fuel cell is higher than the voltage initial value Va, the system controller 7 determines that the fuel cell 1 is in the initial state. That is, the controller 7 judges that the fuel is fully supplied to the fuel electrode side in the fuel cell.

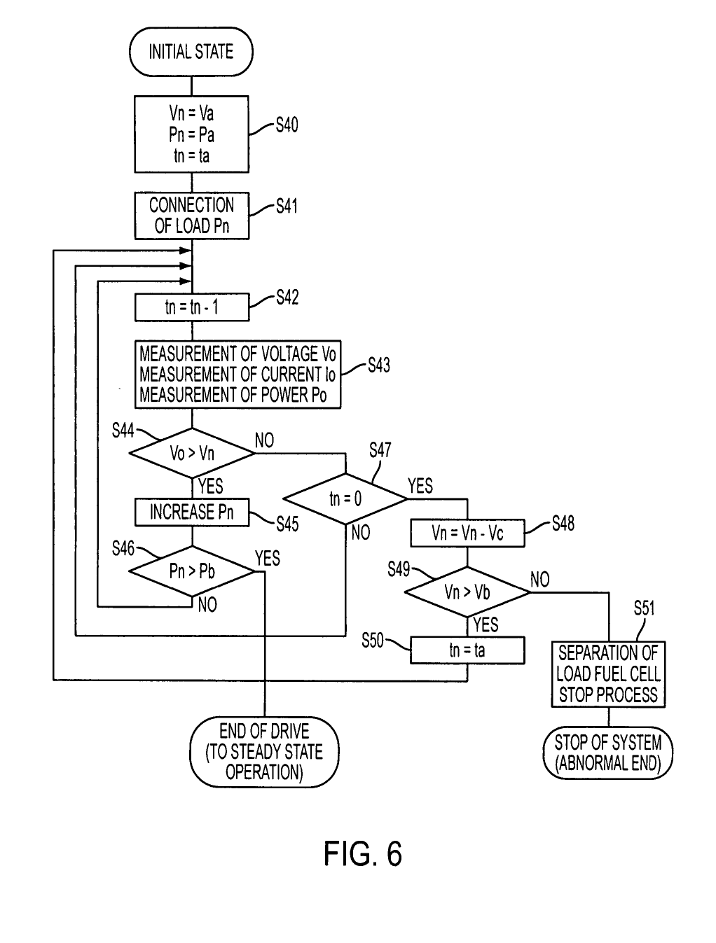

FIG. 6 illustrates the system structure of FIG. 1 until the fuel cell 1 shifts, from the initial state thereof, to the steady state operation after completion of the control required at the time of drive. In this operation, control is performed with reference to the voltage.

Next, the fuel cell drive process in the system structure of the system of FIG. 1 will be explained with reference to FIG. 6.

When the system controller 7 determines that the fuel cell 1 is in the initial state, it sets a drive load Pn, which by non-limiting examples may be a variable power load, a load consuming power, or a variable resistance load, to a load consuming power initial value Pa from a voltage initial value Va×current initial value Ia by setting a voltage Vn to the voltage initial value Va and a current In to the current initial value Ia. Moreover, the controller 7 sets the specified number of times of repetition ta to the present number of times of repetition tn. (Step S40)

The system controller 7 generates the drive signal D2 for the load switch 4 and the load switch 4 connects the load to be connected to the drive load Pn by receiving the drive signal D2. (Step 41)

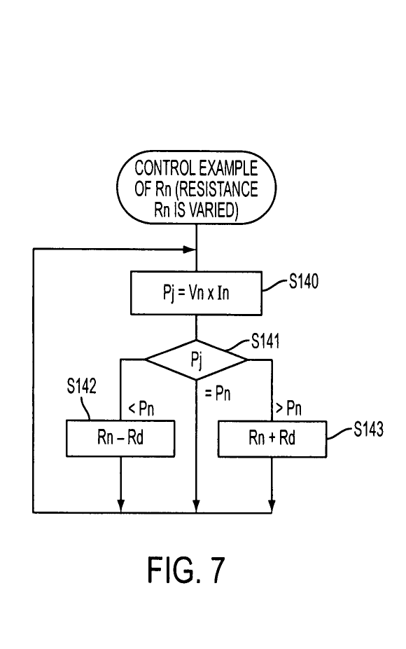

In the circuit operation by the load switch 4 to connect the load to the drive load Pn, when the voltage V1 is set to the low voltage and the voltage V2 to the high voltage as explained with reference to FIG. 3, the current outputted from the fuel cell 1 flows into the drive load Pn in the drive load unit 8. Moreover, control of the variable drive resistance load Pn will be explained later with reference to FIG. 7.

The system controller 7 decrements the present number of times of repetition tn. (Step S42)

The voltage-current detector 2 measures a voltage Vo and a current Io and calculates a power Po by voltage Vo×current Io. (Step S43)

The measured voltage Vo is inputted to the system controller 7 as the sense signal. The system controller 7 determines whether the voltage Vo is equal to or larger than the setting value Vn, namely determining whether the voltage Vo is equal to the voltage initial value Va or higher. (Step S44)

When the voltage Vo is equal to or higher than the setting value Vn, the system controller 7 generates, for the drive load unit 8, the drive signal D3 to increase (by a step) the drive load Pn, and the drive load unit 8 increases the drive load Pn (by a step) upon receiving the drive signal D3. (Step S45)

The drive load unit 8 controls the drive load Pn to a constant value by varying an internal resistance Rn of the field effect transistor (FET), namely in the drive load Pn. Here, the drive load Pn of the drive load unit 8 can be increased step by step, by varying an amount of change in accordance with a numerical step sequence within the system controller 7 or by varying an amount of change in accordance with an input. The system controller 7 generates the drive signal D3 to the drive load unit 8, and the drive load unit 8 having received the drive signal D3 varies the drive load Pn corresponding to the varied amount of change in accordance with the input. The drive load Pn increases as much as the amount of change is kept at a constant value through the control in FIG. 7 which will be explained later.

As explained above, the fuel cell 1 is capable of conducting voltage control without resulting in a sudden change in the fuel cell body while the fuel cell shifts to the drive condition from the initial state, by increasing step by step the drive load Pn.

Moreover, since the drive load Pn increases step by step while the voltage Vo is measured, a highly reliable fuel cell device ensuring stable loading operation can be realized.

In addition, since the drive load Pn can be varied step by step, a large amount of current during the change of load for each timing to vary the drive load can be detected easily and a penetrating time of fuel can also be assumed. Therefore, the optimum penetrating time can be set for every timing of the drive load and it is no longer required to change the load which unnecessarily requires a longer period of time.

The system controller 7 has previously set an upper limit value Pb in the drive state of the load consumption power for the drive load Pn.

The system controller 7 determines whether the drive load Pn has increased up to the upper limit Pb in the drive state or not. (Step S46)

When the system controller 7 determines that the drive load Pn is lower than the upper limit Pb in the drive state, the operation returns to the step S42 for continuation of the drive state.

The voltage-current detector 2 continues measuring the voltage Vo, current Io, and power Po until a constant or fixed time has passed and the measured values are inputted to the system controller 7 as the sense signals.

Moreover, upon determining that the drive load Pn is higher than the upper limit value Pb in the drive state, the system controller 7 generates the drive signal D2 to the load switch 4 in order to complete the control in the drive state of the fuel cell, and the end of the drive operation has been reach and the load switch 4 shifts the system state to the steady state by switching the load to be connected to the load 10, such as the personal computer from the drive load unit 8 by receiving the drive signal D2.

The processes in the route to the step S46 from the step S42 are executed when the voltage Vo rises up to the voltage initial value Va.

Moreover, the system controller 7 having received the value measured by the voltage-current detector 2 in the step S44 with the sense signal determines whether the voltage Vo is equal to or higher than the setting value, namely determining whether the voltage Vo is equal to or higher than the voltage initial value Va. When the voltage Vo is lower than the setting value Va, the system controller 7 determines whether the present number of times of repetition tn is 0 or not. (Step S47)

When tn=0 is not attained, the operation returns to the step S42. The voltage-current detector 2 continuously measures the voltage Vo, current Io, and power Po until the constant time has passed. The measured values are inputted to the system controller 7 as the sense signals.

When the voltage Vo in the steps from S42 to S44 is equal to or lower than the voltage initial value Va, the process in the step S47 is executed and the processes in the route for returning to the step S42 are executed when the voltage Vo does not rise up to the voltage initial value Va while the present number of times of repetition tn is equal to the specified number of times of repetition ta.

Moreover, when tn=0 is established in the step S47, the voltage Vo does not rise up to the voltage initial value Va while the present number of times of repetition tn is equal to the specified number of times of repetition ta. Therefore, the setting value Vn is reduced as much as the amount of change Vc of voltage until it becomes equal to the setting value Vn—amount of change in voltage Vc. Thereafter, this value is determined as the setting value Vn. (Step S48)

The system controller 7 previously set the lower limit value of voltage Vb for the setting value Vn of voltage. The voltage-current detector 2 receives the sense signal of the setting value Vn to determine whether the setting value Vn is equal to or higher than the lower limit value of voltage Vb. (Step S49)

As explained above, the voltage is lowered to the lower limit value of voltage Vb, allowed as the lower limit of voltage by reducing in small increments the amount of change in voltage Vc from the voltage initial value Va of the fuel cell 1.

When the system controller 7 determines, in the step S49, that the setting value Vn is higher than the lower limit value of voltage Vb, the present number of times of repetition tn is set again to the specified number of times of repetition ta. The setting value Vn is changed to the value of setting value Vn—amount of change in voltage Vc and this value is set as the new initial value. Thereafter, the operation returns to the step S42.

The system controller 7 having received the values measured with the voltage-current detector 2 with the sense signal determines whether the voltage Vo is equal to or higher than the setting value Vn being set as the new initial value, here, the value obtained by setting value Vn—amount of change in voltage Vc.

When the voltage Vo is lower than the setting value Vn being set as the new initial value, the processes in the steps S44 to S47 and the processes in the route from the steps S47 to S50 are conducted. In this case, the amount of change in voltage Vc is reduced again from the setting value Vn, a determination is performed in the step S44 using the setting value Vn from which the amount of change in voltage Vc has been reduced, and the processes in the route in the steps to S46 from S44.

Moreover, the system controller 7 will probably reduce the setting value Vn to the lower limit value of voltage Vb in the step S49 by receiving the sense signal of the setting value Vn measured with the voltage-current detector 2. However, when the setting value Vn is determined to be lower than the lower limit value of voltage Vb, it is considered that this event suggests that the fuel cell 1 is defective or the fuel cell 1 is in an irregular state where voltage does not rise because the fuel has been consumed.

Therefore, the system controller 7 generates the drive signal D2 to the load switch 4 in order to stop the operation of the fuel cell. The load switch 4 receives this drive signal D2 and separates the drive load provided in the connected drive load unit 8.

In view of suspending operations of the fuel cell (step S51), the system controller 7 generates the drive signal D1 to the fuel supply system controller 5. The fuel supply system controller 5 receives the drive signal D1 and conducts a completing process such as a process to exhaust the fuel remaining in the fuel cell.

FIG. 7 is a flowchart showing an example of control of a variable resistance Rn of the drive load Pn in the drive load unit 8. As a resistor, a static resistance such as a transistor or a load by a switching operation may be used.

Here, the field effect transistor (FET) shown in FIG. 4 is used as an example. The variable resistance Rn within the field effect transistor is varied to control the drive load Pn to a constant value.

Next, internal operations of the drive load unit 8 in the system of FIG. 1 will be explained with reference to FIG. 7. First, upon receipt of an operating instruction, the system controller 7 corresponding to the controller generates, to the fuel cell 1, the sense signal to drive the fuel cell 1. The voltage-current detector 2 measures the voltage Vn as the battery voltage information from the fuel cell 1 and the current In as the current information to calculate the power Pj (=Vn×In). (Step S140) Namely, the drive load Pn is controlled by measuring the power Pj.

The system controller 7 having received the power information from the voltage-current detector 2 compares the calculated power Pj with the power consumption initial value as the drive load Pn. (Step S141)

When the calculated power Pj is determined to be lower than the power consumption initial value, the system controller 7 generates the drive signal D3 to the drive load unit 8. The drive load unit 8 receives the drive signal D3 and subtracts an adequate resistance value Ra from the variable resistance Rn in the drive load Pn. (Step S142) Therefore, the resistance is reduced, the current flowing into the drive load unit 8 increases, thereby the calculated power Pj increases and comes close to the power consumption initial value.

Moreover, when the calculated power Pj is judged to be identical to the power consumption initial value, the system controller 7 does not generate the drive signal to the drive load unit 8 and thereby the variable resistance Rn in the drive load Pn remains as it is.

In addition, when the calculated power Pj is judged to be higher than the power consumption initial value, the system controller 7 generates the drive signal D3 to the drive load unit 8. The drive load unit 8 receives the drive signal D3 and adds the adequate resistance value Ra to the variable resistance Rn in the drive load Pn. (Step S143) Accordingly, as the resistance increases, the current In flowing into the drive load unit 8 is reduced, and the calculated power Pj is reduced and comes close to the power consumption initial value.

As explained above, when the drive process of the fuel cell 1 is conducted by repeating the control operation of the drive load Pn in the drive load unit 8, the power consumption initial value as the drive load Pn can be kept constant in every timing by varying the variable resistance Rn.

Moreover, the drive load Pn can be increased step by step with a method wherein the system controller 7 varies an amount of change using a numerical step sequence or table indicating load variable ratios and with the method varies the amount of change through direct input.

Numerical values in the numerical step sequence indicating the load variable ratios are provided to incrementally increase in small amounts the load at the initial time of driving the fuel cell, to make comparatively larger in an intermediate stage, and to make comparatively small again the amount of increase in the load at the value near the upper limit value Pb at the time of the load consumption power drive. With use of the numerical step sequence, the fuel cell 1 can be set to the steady state operation in the shortest period of time and therefore numerical values in the numerical step sequence can always be updated in accordance with the state of fuel cell 1.

The system controller 7 generates the drive signal D3 to the drive load unit 8 and the drive load unit 8 having received the drive signal D3 varies the drive load Pn as much as the amount of change. The drive load Pn having increased as much as the amount of change is kept to a constant value under the control of FIG. 7.

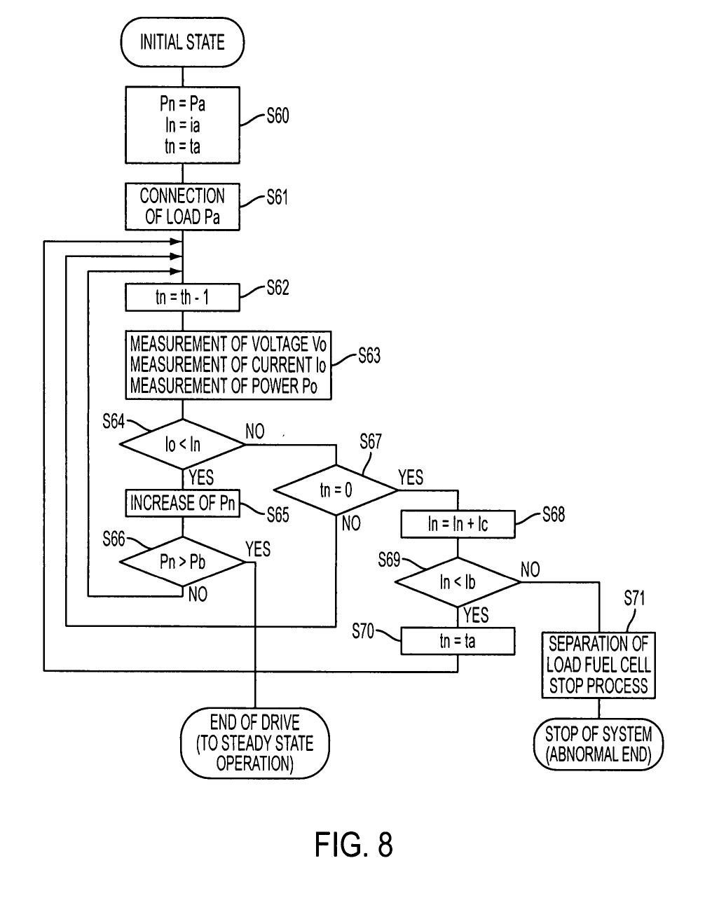

FIG. 8 illustrates the system structure of FIG. 1 until the fuel cell 1 shifts to the steady state operation after completion of control in the drive time from the initial state thereof. Here, the control is conducted with reference to the current.

Next, the fuel cell drive process of the system structure of FIG. 1 will be explained with reference to FIG. 8.

Upon determining that the fuel cell 1 is in the initial state, the system controller 7 sets the load consumption value as the drive load Pn to the load consumption power initial value Pa with current initial value Ia×voltage initial value Va by setting the current In to the current initial value Ia and the voltage Vn to the voltage initial value Va and moreover sets the specified number of times of repetition ta of the present number of times of repetition tn. (Step S60)

The system controller 7 generates the drive signal D2 to the load switch 4 and the load switch 4 receives the drive signal D2 to connect the load connected to the variable drive resistance load Pn. (Step S61)

In the circuit operation by the load switch 4 to connect the load to the drive load Pn, the current outputted from the fuel cell 1 flows into the drive load Pn in the drive load unit 8 by setting the voltage V1 to the low voltage and the voltage V2 to the high voltage as explained in FIG. 3.

The system controller 7 measures the present number of times of repetition tn. (Step S62)

The voltage-current detector 2 calculates the voltage Vo and the current Io and calculates the power Po with voltage Vo×current Io. (Step S63)

The measured current Io is inputted to the system controller 7 as the sense signal. The system controller 7 determines whether the current Io is equal to or less than the setting value In, here, the current initial value Ia. (Step S64)

When the measured current Io is equal to or less than the setting value In, the system controller 7 generates the drive signal D3 to the drive load unit 8 in order to increase step by step the drive load Pn and the drive load unit 8 receives the drive signal D3 to increase step by step the drive load Pn. (Step S65)

The drive load unit 8 controls the drive load Pn to a constant value by varying a variable resistance Rn in the field effect transistor (FET), namely in the drive load Pn. Here, the drive load Pn in the drive load unit 8 can be increased step by step with a method where the system controller 7 varies an amount of change with a numerical step sequence and with a method where an amount of change is varied with input. The system controller 7 generates the drive signal D3 to the drive load unit 8 and the drive load unit 8 having received the drive signal D3 varies the drive load Pn as much as the amount of change. The drive load Pn having increased in the amount of change is kept to a constant value under the control in FIG. 7 explained above.

As explained above, voltage control of the fuel cell 1 can be realized without giving sudden change thereto under the condition that the fuel cell 1 is driven from the initial state by increasing step by step the drive load Pn.

Moreover, since the drive load Pn increases step by step with measurement of the current Io, stable load operation can be conducted and thereby a highly reliable fuel cell can be realized.

Moreover, an amount of current during variation of a load can be detected easily for every timing of variation of each drive load and the penetrating time of fuel can be assumed for change in step by step.

Next, the system controller 7 presets the upper limit value Pb in the drive period of the load consumption power for the drive load Pn.

The system controller 7 determines whether the drive load Pn has increased up to the upper limit value Pb in the drive period (step S66).

The system controller 7 returns to the step S62 for continuation of drive of the fuel cell, upon determination that the drive load Pn is lower than the upper limit value Pb during the drive period.

Moreover, the voltage-current detector 2 continuously measures the voltage Vo, current Io and power Po until the constant time has passed and inputs the measured values to the system controller 7 as the sense signals.

In addition, the system controller 7 generates, upon judgment that the drive load Pn is higher than the upper limit value Pb in the drive period, the drive signal D2 to the load switch 4 to complete the control in the drive period of the fuel cell and the load switch 4 receives the drive signal D2 and switch the load connected to the load 10 such as personal computer from the drive load in the drive load unit 8 in order to shift the state of system to the steady state operation.

The processes in the route of the step S62 to step S66 are executed when the current does not increase up to the current initial value Ia.

Moreover, the system controller 7 having received the values measured by the voltage-current detector 2 with the sense signal in the step S64 determines whether the current is equal to or higher than the setting value In, here the current initial value Ia. When the current Io is higher than the setting value In, this system controller 7 determines whether the present number of times of repetition tn is 0 or not. (Step S67)

When tn does not 0 (tn≠0), the process returns to the step S62. The voltage-current detector 2 continuously measures the voltage Vo, current Io and power Po until the constant time has passed and inputs the measured values to the system controller 7 as sense signals.

When the current Io is equal to or greater than the current initial value Ia in the steps S62 to SS64, the processes in the route returning to the step S62 after execution of the step S67 are executed when the current Io increases up to the current initial value Ia when the present number of times of repetition tn is equal to the specified number of times of repetition ta.

Moreover, when tn=0 is attained in the step S67, the current Io increases up to the current initial value Ia when the present number of times of repetition tn is equal to the specified number of times of repetition ta. Therefore, the setting value In is increased by an amount of change Ic of current up to the setting value In+amount of increase Ic in current and this setting value In+changing amount of current Ic is defined as the setting value In. (Step S68)

The system controller 7 presets the upper limit value of current Ib for the setting value

In of the current. The system controller 7 also receives the sense signal of the setting value In measured with the voltage-current detector 2 and determines whether the setting value In is equal to or less than the upper limit value of current Ib. (Step S69)

As explained above, the current is increased up to the upper limit value of current Ib allowed as the upper limit of current by increasing in small increments the changing amount of current Ic from the current initial value Ib of the fuel cell 1.

Upon determination that the setting value In is lower than the upper limit value of current Ib in the step S69, the system controller 7 sets again the present number of times of repetition tn to the specified number of times of repetition ta. After the setting value In is changed to the value, setting value In +changing amount of current, as the new initial value, the process returns to the step S62.

The system controller 7 having received the values measured with the voltage-current detector 2 determines whether the current Io is equal to or less than the setting value In being set as the new initial value.

When the current Io is higher than the setting value In which has been set as the new initial value, the processes in the route up to the step S67 from the step S64 and in the route up to the step S70 from the step S67 are executed. In this case, however, the setting value In is increased again as much as the changing amount of current Ic and the processes in the route up to the step S66 from the step S64 are executed upon determination in the step S64 using the value of the setting value increased as much as the changing amount of current Ic.

Moreover, the system controller 7 probably increases the setting value In higher than the upper limit value of current Ib in the step S69 by receiving the sense signals of the setting value In measured by the voltage-current detector 2. However, when it is determined that the setting value In is greater than the upper limit value of current Ib, it is assumed that the fuel cell 1 is defective.

Therefore, the system controller 7 generates the drive signal D2 for the load switch 4 to suspend operation of the fuel cell 1 and the load switch 4 receives the drive signal D2 to separate the drive load in the connected drive load unit 8. In order to execute the fuel cell operation stop process (step S71), the system controller 7 generates the drive signal D1 to the fuel supply system controller 5 and the fuel supply system controller 5 receives the drive signal D1 to execute the process to exhaust the fuel in the fuel cell.

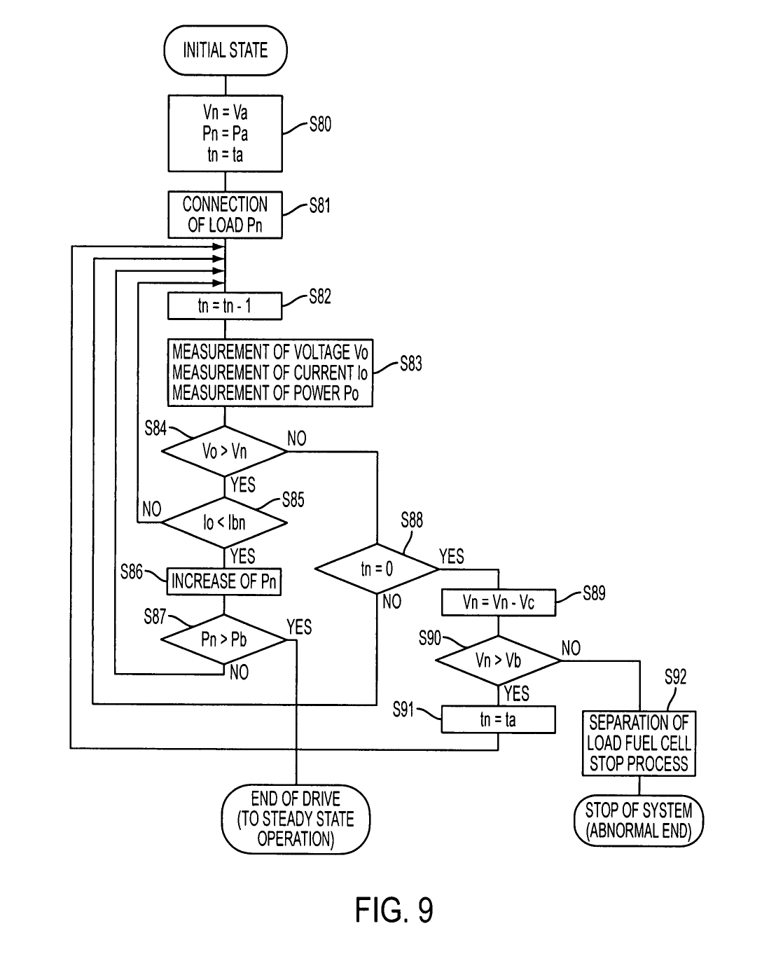

FIG. 9 illustrates operations in the system structure of FIG. 1 until the fuel cell 1 shifts to the steady state operation from the initial state after the control in the drive period. Drive control of the fuel cell 1 is executed by using a limitation on the current Io before varying of the drive load in the drive load unit 8 and with reference to the voltage Vo.

Next, the fuel cell drive process within the system structure in the system of FIG. 1 will be explained with reference to FIG. 9.

The system controller 7 sets, upon determination that the fuel cell 1 is in the initial state, the load consumption power value as the drive load Pn to the load consumption power initial value Pa with the voltage initial value Vz×current initial value Ia by setting the voltage Vn to the voltage initial value Va and the current In to the current initial value Ia and also sets the initial value ta of the specified time tn. (Step S80)

The system controller 7 generates the drive signal D2 to the load switch 4 and the load switch 4 connects the load connected to the drive load Pn by receiving the drive signal D2. (Step S81)

In the circuit operation of the load switch 4 to connect the load to the variable drive resistance load Pn, the current outputted from the fuel cell 1 flows into the drive load Pn in the drive load unit 8 when the voltage V1 is set to the low voltage and the voltage V2 to the high voltage as explained above.

The system controller 7 measures the present number of times of repetition tn. (Step S82)

The voltage-current detector 2 measures the voltage Vo and the current Io to calculate the power Po with the voltage Vo×the current Io. (Step S83)

The voltage Vo measured is inputted to the system controller 7 as the sense signal. The system controller 7 determines whether the voltage Vo is equal to or greater than the setting value Vn, here the voltage initial value Va. (Step S84)

When the voltage Vo is equal to or greater than the setting value Vn, the system controller 7 determines whether the current Io measured with the voltage-current detector 2 is less than the upper limit value of current Ibn at each voltage. (Step S85) When the current Io is higher than the upper limit value of current Ibn at each voltage, the process returns to the step S82.

Moreover, when the current Io is less than the upper limit value of current Ibn at each voltage, the system controller 7 generates the drive signal D3 for increasing the drive load Pn step by step to the drive load unit 8 and the drive load unit 8 receives this drive signal D3 and increases step by step the drive load Pn. (Step S86)

The drive load unit 8 controls the drive load Pn to the constant value by varying a variable resistance Rn of the field effect transistor (FET), namely in the drive load Pn. Here, the drive load Pn of the drive load unit 8 can be increased step by step with the method that the system controller 7 varies an amount of change with a numerical step sequence and with a method that the amount of change is varied with an input. The system controller 7 generates the drive signal D3 to the drive load 8 and the drive load unit 8 having received the drive signal D3 varies the drive load Pn as much as the amount of change. The drive load Pn which has increased as much as the amount of change is kept to the constant value under the control of FIG. 7 explained above.

As explained above, voltage control can be performed without any sudden change of the fuel cell 1 while the cell shifts to the drive period from the initial state.

Moreover, since the drive load Pn increases step by step while measurement of the current Io, the highly reliable fuel cell assuring the stable load operation can be realized.

In addition, since the drive load Pn is changed step by step, an amount of heavy current in variation of load at each timing of variation of each drive load can be detected easily and the penetrating time of fuel can also be assumed. Accordingly, the optimum penetrating time can be set for each timing of each drive load and it is no longer required to vary the load in an unnecessary longer period.

Next, the system controller 7 presets the upper limit value Pb in the drive period of the load consumption power for the drive load Pn.

The system controller 7 determines whether the drive load Pn has increased up to the upper limit value Pb in the drive period. (Step S87)

When the system controller 7 determines that the drive load Pn is lower than the upper limit value Pb in the drive period, the process returns to the step S82 for continuation of drive of the fuel cell 1.

The voltage-current detector 2 continuously measures the voltage Vo, current Io and power Po until the constant period has passed and inputs the measured values to the system controller 7 as sense signals.

Moreover, the system controller 7 generates, upon determination that the drive load Pn is greater than the upper limit value Pb in the drive period, the drive signal D2 is applied to the load switch 4 to complete the control in the drive period of the fuel cell. The load switch 4 receives the drive signal D2, switches the load connected to the load 10 such as the personal computer from the drive load in the drive load unit 8 and then shifts the state of the system to the steady state.

The processes in the route up to the step S87 from the step S82 are executed when the voltage Vo increases up to the voltage initial value Va and the current Io is equal to or less than the upper limit value of the current Ibn.

Moreover, the system controller 7 having received the value measured with the voltage-current detector 2 in the step S84 with the sense signal determines whether the voltage Vo is equal to or greater than the setting value Vn, here the voltage initial value Va. When the voltage Vo is less than the setting value Va, the system controller 7 determines whether the present number of times of repetition tn is 0. (Step S88)

When tn≠0, the process returns to the step S82. The voltage-current detector 2 continuously measures the voltage Vo, current Io and power Po until the constant period has passed and inputs the measured values to the system controller 7 as the sense signals.

When the voltage Vo is equal to or less than the voltage initial value Va in the steps up to S84 from the step S82, the process of the step S88 is executed and the processes of the route to return to the step S82 are executed when the voltage Vo does not increase up to the voltage initial value Va while the present number of times of repetition tn is the specified number of times of repetition ta.

When tn=0 in the step S88, the voltage Vo does not increase up to the voltage initial value Va while the present number of times of repetition tn is the specified number of times of repetition ta. Therefore, the setting value Vn is reduced to the setting value Vn—amount of change of voltage Vc through reduction as much as the amount of change Vc of voltage and this value, setting value Vn—amount of change of voltage Vc is set as the setting value Vn. (Step S89)

The system controller 7 presets the lower limit value of voltage Vb to the setting value Vn of voltage. This system controller 7 determines whether the setting value vn is equal to or greater than the lower limit value of voltage Vb by receiving the sense signal of the setting value Vn measured with the voltage-current detector 2. (Step S90)

As explained above, the voltage is reduced up to the lower limit value of voltage Vb which is allowed as the lower limit value of the voltage by reducing in small increments the amount of change of voltage Vc from the voltage initial value Va of the fuel cell 1.

Upon determination that the setting value Vn is greater than the lower limit value of voltage Vb in the step S90, the system controller 7 sets again the present number of times of repetition tn to the specified number of times of repetition ta. The setting value Vn is changed to the setting value Vn—amount of change of voltage Vc. This value is set as the new initial value and the process returns to the step S82.

The system controller 7 having received the values measured with the voltage-current detector 2 as the sense signals determines whether the voltage Vo is equal to or greater than the setting value Vn being set as the new initial value, here the setting value Vn—amount of change of voltage Vc.

When the voltage Vo is lower than the setting value Vn which has been set as the new initial value, the processes in the route up to the step S88 from the step S84 and in the route up to the step S91 from the step S88 are executed. In this case, an amount of change of voltage Vc is reduced from the setting value Vn and a determination is also conducted in the step S84 using the value equal to the setting value Vn—amount of change of voltage Vc. Here, the processes in the route up to the step S87 from the step S84 are executed.

Moreover, the system controller 7 possibly reduces the setting value Vn up to the lower limit value of voltage Vb in the step S90 by receiving the sense signal of the setting value Vn measured with the voltage-current detector 2. However, when the setting value Vn is judged to be less than the lower limit value of voltage Vb, the fuel cell 1 is assumed to be in the defective state or in an irregular state where voltage does not increase because the fuel has been consumed.

Therefore, the system controller 7 generates the drive signal D2 to the load switch 4 in view of suspending the operation of the fuel cell. The load switch 4 receives the drive signal D2 and separates the drive load in the connected drive load unit 8.

The system controller 7 generates the drive signal D1 to the fuel supply system controller 5 to execute the fuel cell stop process (step S92). The fuel supply system controller 5 receives the drive signal D1 to execute the completing process such as the process to exhaust the fuel in the fuel cell.

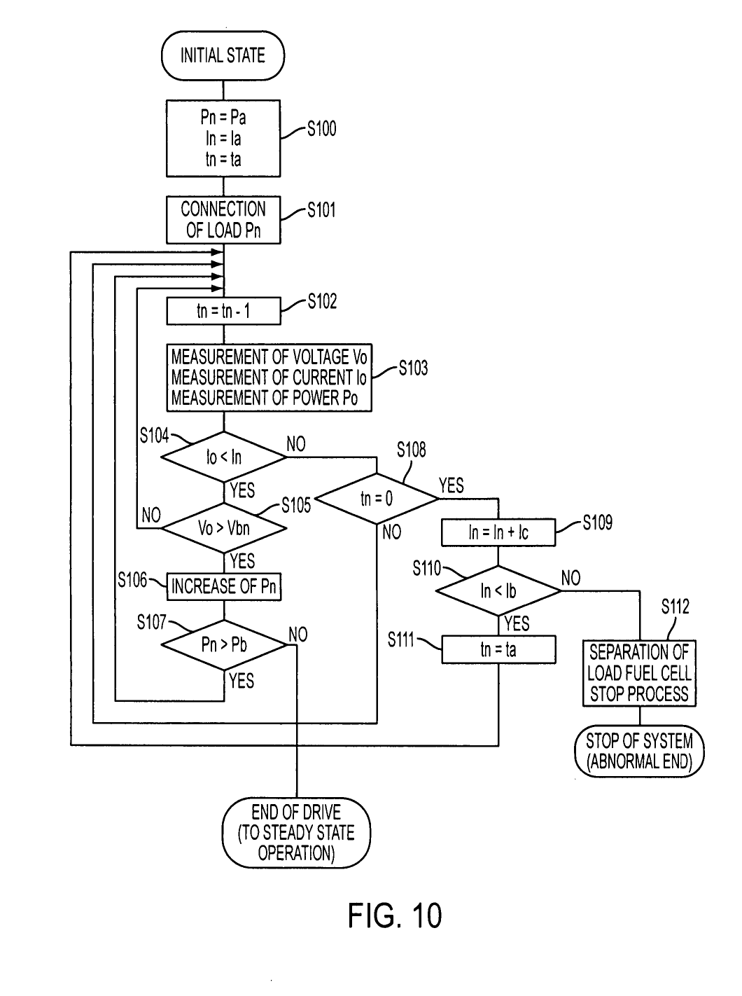

FIG. 10 illustrates the system structure of FIG. 1 until the fuel cell 1 shifts to the steady state operation from the initial state after completion of the control in the drive period. Drive control of the fuel cell 1 can be executed by conducting the control with reference to the current and confirming control of the voltage Vo before the drive load in the drive load unit 8 is varied.

Next, the fuel cell drive process in the system structure of the system of FIG. 1 will be explained with reference to FIG. 10.

Upon determination that the fuel cell 1 is in the initial state, the system controller 7 sets the load consumption power value as the drive load Pn to the load consumption power initial value Pa with the voltage initial value Va×current initial value Ia by setting the voltage Vn to the voltage initial value Va and the current In to the current initial value Ia and also sets the specified number of times of repetition ta to the present number of times of repetition tn. (Step 100)

The system controller 7 generates the drive signal D2 to the load switch 4 and the load switch 4 receives the drive signal D2 to connect the load connected to the variable drive resistance load Pn. (Step S101)

In circuit operations of the load switch 4 to connect the load to the drive load Pn, the current outputted from the fuel cell 1 flows into the drive load Pn in the drive load unit 8 when the voltage V1 is set to the low voltage and the voltage V2 to the high voltage as explained in FIG. 3.

The system controller 7 measures the specified time tn. (Step S102)

The voltage-current detector 2 measures the voltage Vo, current Io, and power Po to calculate the power Po with the voltage Vo×the current Io. (Step S103)

The current Io measured is inputted to the system controller 7 as the sense signal. The system controller 7 determines whether the current Io is equal to or lower than the setting value, here the current initial value Ia. (Step S104)

When the current Io is lower than the setting value In, the system controller 7 determines whether the voltage Vo measured with the voltage-current detector 2 is greater than the lower limit value of voltage Vbn at each current. (Step S105) When the voltage Vo is less than the lower limit value of voltage Vbn at each current, the process returns to the step S102.

Moreover, when the voltage Vo is equal to or higher than the lower limit value of voltage Vbn at each current, the system controller 7 generates the drive signal D3 to increase step by step the drive load Pn to the drive load unit 8. The drive load unit 8 receives the drive signal D3 and increases the drive load Pn step by step. (Step S106)

The drive load unit 8 in FIG. 4 controls the drive load Pn to the constant value by varying the variable resistance Rn of the field effect transistor (FET), namely the drive load Pn. Here, the drive load Pn of the drive load unit 8 can be increased step by step with a method that the system controller 7 varies an amount of change with a numerical step sequence or with a method that an amount of change is varied with input. The system controller 7 generates the drive signal D3 to the drive load unit 8 and the drive load unit 8 having received the drive signal D3 varies the drive load Pn as much as the amount of change. The drive load Pn increased as much as the amount of change is kept at the constant value under the control of FIG. 7 explained above.

As explained above, voltage control can be performed without giving any sudden change of the fuel cell in the drive period from the initial state of the fuel cell 1 by increasing step by step the drive load Pn.

Moreover, the highly reliable fuel cell assuring stable load operations can be realized because the drive load Pn is increased step by step while measuring the voltage Vo.

Moreover, since the drive load Pn is increased step by step, heavy current during variation of current in each timing of variation of the drive load can be detected easily and penetrating time of fuel can also be assumed. Accordingly, the optimum penetrating time can be set for each timing of the drive load and it is no longer required to vary the load in an unnecessary longer period.

Next, the system controller 7 presets the upper limit value Pb in a drive period of the load consumption power to the drive load Pn.

The system controller 7 determines whether the drive load Pn has increased up to the upper limit value Pb in drive period. (Step S107)

When the system controller 7 returns, upon determination that the drive load Pn is less than the upper limit value in the drive period, to the step S102 for continuous drive.

The voltage-current detector 2 continuously measures the voltage Vo, current Io, and power Po until the constant period has passed and inputs the measured values to the system controller 7 as sense signals.

The system controller 7 generates, upon determination that the drive load Pn is greater than the upper limit value Pb in the drive period, the drive signal D2 to the load switch 4 in order to complete the control in the drive period of the fuel cell 1. The load switch 4 receives the drive signal D2 and switches the load connected to the load 10 such as a personal computer from the drive load in the drive load unit 8 in order to shift the system state to the steady state.

The processes in the route up to the step S107 from the step S102 explained above are executed when the voltage Vo increases up to the lower limit value Vbn of voltage.

Moreover, the system controller 7 having received the values measured with the voltage-current detector 2 in the step S104 as the sense signals determines whether the current is equal to or greater than the setting value In, here equal to or lower than the current initial value Ia. When the current Io is greater than the setting value In, the system controller 7 determines whether the present number of times of repetition tn is 0. (Step S108) When tn≠0, the process returns to the step S102. The voltage-current detector 2 continuously measures the voltage Vo, current Io and power Po until the constant period has passed and inputs the measured values to the system controllers 7 as the sense signals.

When the current Io is equal to or greater than the current initial value Ia in the steps to step S104 from the step S102 explained above, the process in the step S108 is executed and the processes in the route returning to the step S102 are executed when the current Io becomes larger than the current initial value Ia while the present number of times of repetition tn is the specified number of times of repetition ta.

When tn=0 in the step S108, the current Io becomes larger than the current initial value Ia while the present number of times of repetition tn is the specified number of times of repetition ta. Accordingly, the setting value In is increased to the setting value In +amount of change Ic of current by increasing amount of change Ic of current and the value of setting value In+amount of change IC of current is set as the setting value In. (Step S109)

The system controller 7 presets the upper limit value Ib of current for the setting value In of current. The system controller 7 receives the sense signal of the setting value In measured with the voltage-current detector 2 and determines whether the setting value In is equal to or less than the upper limit value Ib of current. (Step S110)

As explained above, the current is increased up to the upper limit value Ib of current allowed as the upper limit value of current by increasing little by little the current initial value Ia of the fuel cell 1 as much as the amount of change Ic of current.

The system controller 7 sets again, upon judgment that the setting value In is less than the upper limit value Ib of current in the step S110, the present number of times of repetition tn to the specified number of times of repetition ta. The setting value In is changed to the value, setting value In+amount of change of current Ic and this value is determined as the new initial value. The process then returns to the step S102.

The system controller 7 having received the values measured by the voltage-current detector 2 as the sense signals determines whether the current Io is equal to or less than the setting value In being set as the new initial value.

When the current Io is greater than the setting value In being set as the new initial value, the processes in the route to the step S108 from the step S104 and in the route to the step S111 from the step S108 are executed. In this case, amount of change of current Ic is increased again to the setting value In, judgment is conducted in the step S104 using the value of the setting value In increased in amount of change of current Ic, and the processes in the route up to the step S107 from the step S104 are executed.

Moreover, the system controller 7 possibly receives the sensor signal of the setting value In measured with the voltage-current detector 2 and increases, the setting value In up to the upper limit value Ib of current in the step S110. However, when the setting value In is judged to be greater than the upper limit value Ib of current, the fuel cell 1 is assumed to be defective of in an irregular state.

Therefore, the system controller 7 generates the drive signal D2 to the load switch 4 in order to suspend operations of the fuel cell and the load switch 4 receives the drive signal D2 to separate the drive load within the drive load unit 8 connected.

In view of conducting the fuel cell stop process (step S112), the system controller 7 generates the drive signal D1 to the fuel supply system controller 5 and the fuel supply system controller 5 receives the drive signal D1 and conducts the completing process such as the process to exhaust the fuel in the fuel cell.

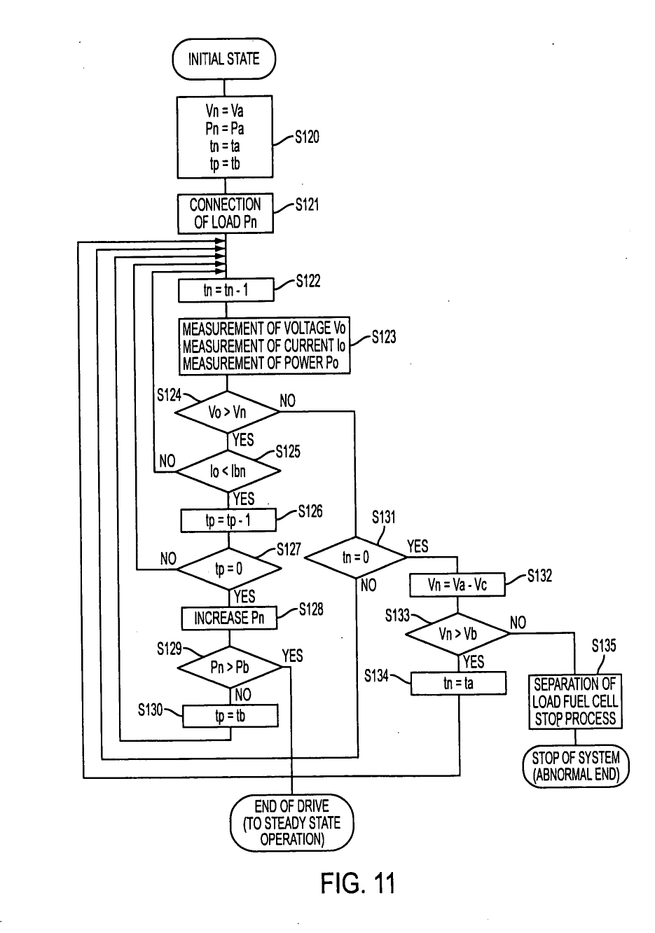

FIG. 11 is a flowchart for explaining operations in the system structure of the fuel 1 until the fuel cell shifts to the steady state operation from the initial state after completion of control in the drive period. Drive control of fuel cell 1 can be performed by executing control with reference to the voltage Vo and confirming limitation of the current Io before the drive load in the drive load unit 8 is varied.

Next, the fuel cell drive process in the system structure of the system of FIG. 1 will be explained with reference to FIG. 11.

The system controller 7 sets, upon judgment that the fuel cell 1 is in the initial state, the load consumption power value Pn to the load consumption power initial value Pa from the voltage initial value Va×current initial value Ia by setting the voltage Vn to the voltage initial value Va and the current In to the current initial value Ia and also sets the specified number of times of repetition ta of the present number of times of repetition tn. Here, ta means a system irregularity monitoring timer. Moreover, the specified number of times of repetition tb of the present number of times of repetition tp waiting for increase in the load is also set. Here, tb means a load increase waiting timer. (Step S120)

The system controller 7 generates the drive signal D2 to the load switch 4 and the load switch 4 receives the drive signal D2 and connects the load connected to the drive load Pn in the drive load unit 8. (Step S121)

In the circuit operations of the load switch 4 to connect the load to the drive load Pn, the current outputted from the fuel cell 1 flows into the drive load Pn in the drive load unit 8 when the voltage V1 is set to the low voltage and the voltage V2 is set to the high voltage as explained above.

The system controller 7 measures the present number of times of repetition tn. (Step S122)

The voltage-current detector 2 measures the voltage Vo, and current Io to calculate the power Po with the voltage Vo×the current Io. (Step S123)

The voltage Vo measured is then inputted to the system controller 7 as the sense signal. The system controller 7 determines whether the voltage Vo is equal to or greater than the setting value Vn, here the voltage initial value Va. (Step S124)

When the voltage Vo is equal to or greater than the setting value Vn, the system controller 7 determines whether the current Io measured by the voltage-current detector 2 is less than the upper limit value of current Ibn at each voltage. (Step S125)

When the current Io is greater than the upper limit value of current Ibn at each voltage, the process returns to the step S122.

Moreover, when the current Io is less than the upper limit value of current Ibn at each voltage in the step S125, the system controller 7 measures the present number of times of repetition tp waiting for increase of load. (Step S126)

When the present number of times of repetition tp waiting for increase of load is equal to 0, the system controller 7 generates the drive signal D3 for increasing step by step the drive load Pn to the drive load unit 8 and the drive load unit 8 receives the drive signal D3 and increases step by step the drive load Pn. (Step S128)

The drive load unit 8 of FIG. 4 controls the drive load Pn to the constant value by varying an internal resistance Rn of the field effect transistor (FET), namely in the drive load Pn. Here, the drive load Pn in the drive load unit 8 can be increased step by step with the method that the system controller 7 varies amount of change with the numerical step sequence or with the method that amount of change is varied with input. The system controller 7 generates the drive signal to the drive load unit 8 and the drive load unit 8 having received the drive signal D3 varies the drive load Pn as much as amount of change. Therefore, the drive load Pn increased as much as amount of change is kept to the constant value under the control of FIG. 7 explained later.

As explained above, voltage control can be performed without giving sudden change to the fuel cell body while the fuel cell 1 shifts to the drive period from the initial state.

Moreover, since the drive load Pn is increased step by step while measurement of the voltage Vo, the highly reliable fuel cell device ensuring stable load operations can be realized.

Moreover, since the drive load Pn is varied step by step, heavy current in variation of load at each timing of the variation of drive load can be detected easily and moreover penetrating time of the fuel can be assumed. Therefore, the optimum penetrating time can be set for each timing of drive load and it is no longer required to vary the load in unnecessary longer period.

Next, the system controller 7 presets the upper limit value Pb in the drive period of the load consumption power to the drive load Pn.

The system controller 7 determines whether the drive load Pn has increased up to the upper limit value Pb in the drive period. (Step S129)

Upon judgment that the drive load Pn is less than the upper limit value Pb in the drive period in the step S129, the system controller 7 resets again the present number of times of repetition tp waiting for increase of load to the specified number of times of repetition tb and the process returns to the step S122 for continuous drive.

Moreover, upon judgment that the drive load Pn is greater than the upper limit value Pb in the drive period in the step S129, the system controller 7 generates the drive signal D2 to the load switch 4 in order to complete control in the drive period of the fuel cell. The load switch 4 receives the drive signal D2 and switches the load connected to the load 10 such as the personal computer from the drive load in the drive load unit 8 in order to shift the system state to the steady state.

The processes in the route to the step S130 from the step S124 are executed when the voltage Vo is increases up to the voltage initial value Va and the current Io is less than the upper limit value of current Ibn.

Moreover, the system controller 7 having received the values measured by the voltage-current detector 2 as the sense signals, determines whether the voltage Vo is equal to or greater than the setting voltage Vn, here the voltage initial value Va in the step S124. When the voltage Vo is less than the setting value Vn, the system controller 7 also determines whether the present number of times of repetition tn is 0. (Step S131)

When tn≠0, the process returns to the step S122. The voltage-current detector 2 continuously measures the voltage Vo, current Io, and power Po until the constant period has passed and then inputs the measured values to the system controller 7 as the sense signals.

When the voltage Vo is equal to or less than the voltage initial value Va in the steps to S124 from S122, the process of the step S131 is executed. The processes in the route returning to the step S122 are executed when the voltage Vo does not increase up to the voltage initial value Va while the present number of times of repetition tn is the specified number of times of repetition ta.

Moreover, when tn=0 in the step S131, since the voltage Vo does not increase up to the voltage initial value Va while the present number of times of repetition tn is the specified number of times of repetition ta, the setting value Vn is reduced as much as amount of change of voltage Vc in order to set a new setting value Vn—amount of change of voltage Vc. (Step S132)

The system controller 7 presets the lower limit value of voltage Vb for the setting value Vn of voltage. The system controller 7 receives the sense signal of the setting value Vn measured with the voltage-current detector 2 and determines whether the setting value Vn is equal to or greater than the less limit value of voltage Vb. (Step S133)

The voltage is reduced in small increments in the amount of change of voltage Vc from the voltage initial value Va of the fuel cell 1 up to the voltage lower limit value of voltage Vb which is allowed as the lower limit value of voltage.

Upon determination that the setting value Vn is greater than the lower limit value of voltage Vb in the step S133, the system controller 7 sets again the present number of times of repetition tn to the specified number of times of repetition ta.

The setting value Vn is changed to the new setting value, setting value Vn—amount of change of voltage Vc. Thereafter, the process returns to the step S122.

The system controller 7 having received the values measured with the voltage-current detector 3 as the sense signals determines whether the voltage Vo is equal to or greater than the setting value Vn being set as the new initial value, here the value, setting value Vn—amount of change of voltage Vc.

When the voltage Vo is less than the setting value Vn being set as the new initial value, the processes in the route of the step S131 from the step S124 and the processes in the route of the step S134 from the step S131 are executed. In this case, the setting value Vn is reduced as much as the amount of change of voltage Vc, a determination is performed in the step S124 using the value, setting value Vn—amount of change of voltage Vc, and the processes in the route of the step S129 from the step S124 are executed.

Moreover, the system controller 7 possibly receives the sense signal of the setting value Vn measured with the voltage-current detector 2 and reduces the setting value Vn up to the lower limit value of voltage Vb in the step S133.

However, when the setting value Vn is determined to be less than the lower limit value of voltage Vb, the fuel cell 1 is assumed to be defective or in the irregular state where the voltage does not increase because the fuel has been consumed.

Therefore, the system controller 7 generates the drive signal D2 to the load switch 4 in order to suspend operation of the fuel cell 1. The load switch 4 receives the drive signal D2 and separates the drive load in the drive load unit 8

Moreover, the system controller 7 generates the drive signal D1 to the fuel supply system controller 5 to execute the fuel cell stop process (step S51) and the fuel supply system controller 5 receives the drive signal D1 and executes the completing process such as the process to exhaust the fuel in the fuel cell.

The voltage-current detector 2 continuously measures the voltage Vo, current Io, and power Po until the constant period has passed and then inputs the measured values to the system controller 7 as the sense signals.

Moreover, the system controller 7 receives, in the step S133, the sense signal of the setting value Vn measured with the voltage-current detector 2 and assumes, upon judgment that the setting value Vn is greater than the lower limit value of voltage Vb, that the fuel cell 1 is in the irregular state.

Therefore, the system controller 7 generates the drive signal D2 to the load switch 4 in order to suspend operation of the fuel cell 1. The load switch 4 receives the drive signal D2 and separates the drive load in the drive load unit 8.

Moreover, the system controller 7 generates the drive signal D1 to the fuel supply system controller 5 in order to execute the fuel cell stop process (step S135). The fuel supply system controller 5 receives the drive signal D1 and executes the completing process such as the process to exhaust the fuel in the fuel cell.

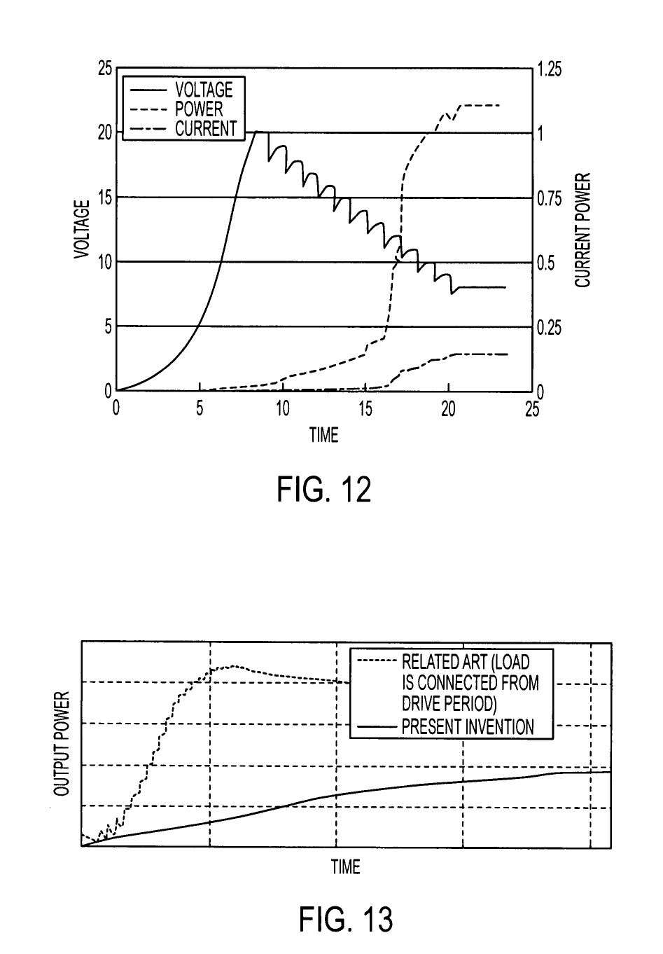

FIG. 12 illustrates changes in the voltage, current, and power measured with the voltage-current detector 2 within the system structure in the system of FIG. 1. Changes in the voltage, current, and power are plotted on the vertical axis, with the time on the horizontal axis.

In FIG. 12, changes in the voltage, current, and power under the control of the illustration recognizing the fuel cell initial state of FIG. 5 are shown from the time 0 to the time 8 on the horizontal axis. The load switch 4 separates any of the loads of the drive load unit 8 and the load 10 such as the personal computer. The system controller 7 generates the drive signal to supply the fuel to the fuel cell. The fuel supply system controller drives the fuel by receiving the drive signal to supply the fuel and oxygen to the fuel cell. When the voltage rises up to a value corresponding to the time 8, it is determined that the fuel has been supplied sufficiently to the fuel electrode side in the fuel cell.

FIG. 12 shows changes in the voltage, current, and power under the control of the illustration recognizing the fuel cell drive process of FIG. 6 after the time 8 on the horizontal axis. Since the drive process of the fuel cell 1 is performed until the time 18 from the time 8 on the horizontal axis, the load switch 4 connects the load to the drive load unit 8 and increases step by step the drive load in the drive load unit 8. When the drive load increases, the voltage is momentarily reduced to a large extent, allowing flow of a heavy current. In this timing, the fuel supplied sufficiently to the fuel electrode side of the fuel cell is momentarily reduced when the drive load increases. Thereafter, after a reasonable time has passed, the state where the fuel is sufficiently supplied to the fuel electrode side appears again and this state is stabilized. After the fuel cell is stabilized, the drive load is increased again and the power is effectively increased while the operation explained above is repeated. As explained above, the liquid fuel can be sufficiently penetrated into the electrolytic film in the fuel cell and thereby an output of the fuel cell can be increased up to the required output.

When the required power can be achieved at the time 18, the fuel cell drive process is completed. The load switch 4 switches the load to the load 10 such as the personal computer from the drive load unit 8. The stable output power can be attained from the fuel cell and the system enters the steady state.

From the above explanation, it is apparent that the time required for drive of the fuel cell 1 can be shortened by increasing step by step the drive load. Moreover, since the drive load is increased step by step while the voltage and current are measured, the highly reliable fuel cell device assuring stable load operation can be realized.

FIG. 13 shows an example of changes in the output of the fuel cell in the case where the load switch 4 separates the target load, such as the personal computer, from the fuel cell in the initial state of the fuel cell like the embodiments discussed herein and in the case where the load is connected in the initial state of the fuel cell.

Changes in the output power of fuel cell is plotted on the vertical axis, while the time on the horizontal axis: As shown in FIG. 13, it is apparent, as a result of comparison with the existing method where the load is connected from the initial state of the fuel cell, that the time required until the target output can be attained is remarkably shortened through employment of the embodiments.

The embodiments relate to the technology for penetrating liquid fuel into the electrolytic film within an MEA (Membrane Electrode Assembly) within a fuel cell.

The drive process in the embodiments indicates the process for shifting the fuel cell to the rated output generation ready state from the operation stoppage state. The fuel cell operation stoppage state indicates the state where the fuel element is removed from the MEA and is then stored under a moist condition.

Moreover, the rated output generation ready state indicates the state where the MEA is filled with the fuel and the fuel is also sufficiently supplied to the electrolytic film at the center of the MEA, namely the state where proton transfer is sufficiently conducted in the entire part of the electrolytic film.

In the existing methods, (1) the load is fixed from the drive period, and (2) the load is continuously varied from the drive period.

(1) In the method where the load is fixed from the drive period, the time is required for the liquid fuel to naturally penetrate into the electrolytic film until the fuel cell shifts to the rated output generation ready state from the operation stoppage state. The time of several hours to several days is required when the electrolytic film is formed of a hydrogen carbide system material.

(2) In the method where the load is continuously varied from the drive period, the time is also required for the liquid fuel to naturally penetrate into the electrolytic film until the fuel cell shifts to the rated output generation ready state from the operation stoppage state. Therefore, molecule activity is activated at the area near the electrolytic film by connecting a load. In this case, heat is also generated. In general, since the electrolytic film can easily show its greater performance when temperature is greater, sufficient penetrating time for electrolytic film and fuel tends to be shortened.

However, when the load is continuously varied, it is difficult to determine the reason why the output has been increased. The first reason assumed involves a heavy current flowing momentarily because the load is varied. That is, an output voltage of a fuel cell does not change momentarily and only the current flows immediately after the load is varied and such current tends to be gradually stabilized to a constant current value. The second reason assumed involves the fuel being sufficiently affiliated with the electrolytic film because the load is increased.

Accordingly, the load must be varied with a sufficiently longer time interval for continuous change of load in the fuel cell.

However, in the embodiments, an amount of heavy current during variation of load can be detected for each timing of load variation in view of varying step by step the load. Moreover, an penetrating time of fuel in load variation can be assumed. Therefore, the optimum penetrating time can be set for each timing in variation of load and thereby it is no longer required to change the load in an unnecessary longer period.

### Second Embodiment

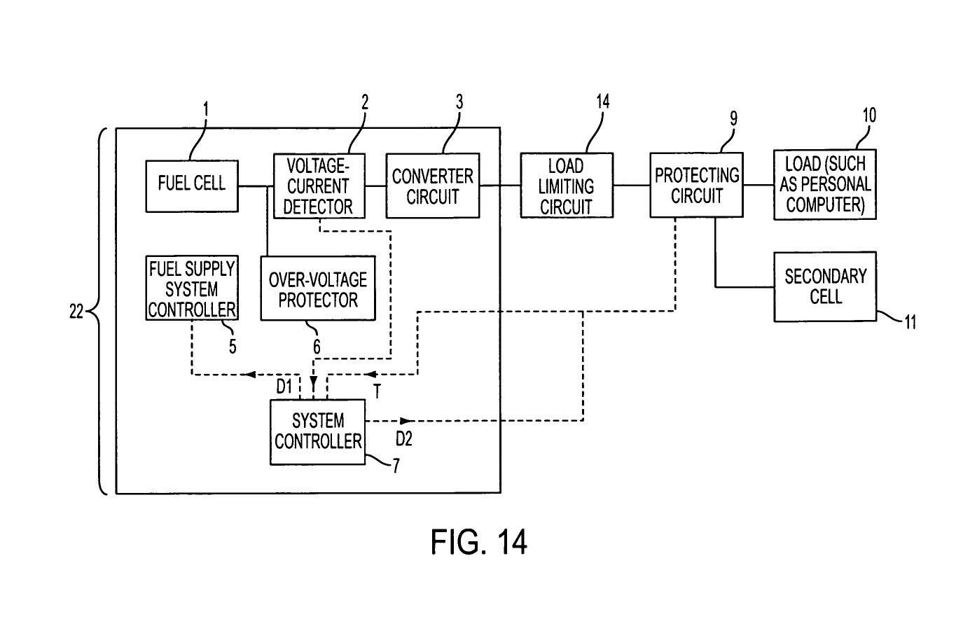

The second embodiment of the present invention will be explained with reference to FIG. 14. FIG. 14 is a diagram showing the total system of the fuel cell device 22 in relation to the second embodiment. The elements like that in FIG. 1 are designated with the like reference numerals in FIG. 14.

In FIG. 14, reference numeral 1 designates a fuel cell; 2, a voltage-current detector; 3, a converter circuit; 14, a load limiting circuit; 5, a fuel supply system controller; 6, an over voltage protector; 7, a system controller; 9, a protecting circuit; 10, a load such as personal computer; 11, a secondary cell; and 22, a fuel cell device.

The fuel cell 1 is connected with the voltage-current detector 2 detecting an output voltage and an output current of the relevant fuel cell, the voltage-current detector 2 with the converter circuit 3, the converter circuit 3 with the load limiting circuit 14, the load limiting circuit 14 with the protecting circuit 9, the protecting circuit 9 with the load 10 such as the personal computer and the secondary cell 11. Moreover, the over-voltage protector 6 is connected between the fuel cell 1 and voltage-current detector 2 to limit an output voltage when the supply of the fuel to the fuel cell 1 starts and the output of the fuel cell 1 rises. Moreover, in the fuel cell device in the second embodiment, the drive load in the fuel cell device in relation to the first embodiment is replaced with the secondary cell and personal computer. That is, the load limiting circuit 14 may be replaced with the secondary cell and personal computer under the condition that the secondary cell and personal computer as the load of fuel cell may be considered as the load almost identical to the output of the fuel cell.

As the fuel to be supplied to the fuel cell, methanol, for example, is supplied to the fuel cell 1 with the fuel supply system controller 5 in accordance with the operation command from the system controller 7.

When the fuel cell 1 is driven, the voltage-current detector 2 detecting an output voltage and an output current of the fuel cell 1 detects the voltage and current of the fuel cell 1 and generates a detection signal L. The detection signal L is then inputted to the system controller 7 as the control information. The system controller 7 receives the detection signal L and generates drive signals D1 and D2. The fuel supply system controller 5 controls supply of the fuel to the fuel cell and starts supply of the fuel to the fuel cell by receiving the drive signal D1. The load limiting circuit 14 limits the load by increasing step by step this load to which the output voltage and output current of the fuel cell flows and also switches the load to the load 10 such as personal computer.

The load limiting circuit 14 increases, step by step, the load of the load limiting circuit 14 by receiving the drive signal D2. Moreover, the load limiting circuit 14 varies the load on the basis of the constant ratio of the voltage or current.

Moreover, the load 10 such as personal computer is influenced by voltage drop or surge due to sudden generation of power and sudden stoppage of operation of the fuel cell 1. In order to prevent failure in the power supply circuit and mother board of the load 10 such as the personal computer due to such influence, the protecting circuit 9 generates a stop signal T and this stop signal T is applied to the system controller 7 as the control information. The system controller 7 is constituted with a microprocessor or the like to execute supply of fuel, stoppage of fuel supply, and load control for the fuel cell 1 based on the control program.

The embodiments discussed herein can provide the following effects.

The embodiments discussed herein relate to a method of driving a fuel cell used in a fuel cell device. According to the embodiments, the fuel cell device can detect a heavy current due to variation of a load in every variable timing of each load because the load is varied step by step. Moreover, penetrating time of the fuel during variation of each load can be assumed.

Namely, the optimum penetrating time can be set for each variable timing of each load and it is no longer required to realize change of load requiring an unnecessary longer time and therefore the drive process can be realized within a short period of time.

Moreover, a highly reliable fuel cell device can be realized through stable loading operation.

What is claimed is:

1. A fuel cell device supplying electrical power to a connected steady state load when said fuel cell is in a steady state, comprising:
a drive load;
a load switching controller connecting any of the steady state load and said drive load to said fuel cell; and
a load adjusting controller adjusting a value of said drive load,
wherein
said load switching controller connects said drive load to said fuel cell at a time of driving said fuel cell,
said load adjusting controller increases said value of said drive load step by step, and
said load switching controller switches, when said drive load has reached a predetermined value, the load of said fuel cell to said steady state load from said drive load.

2. The fuel cell device of claim 1, further comprising an over-voltage protector connected to the fuel cell to restrict an output voltage of the fuel cell when an output voltage of the fuel cell rises.

3. The fuel cell device of claim 1, further comprising:
a voltage-current detector detecting an output voltage and an output current of the fuel cell, and generating a detection signal from the detected output voltage and the detected output current; and
a system controller generating drive signals from the generated detection signal.

4. The fuel cell device of claim 3, further comprising a fuel supply system controller controlling a supply of fuel to the fuel cell, and starting the supply of fuel to the fuel cell with a first drive signal of the generated drive-signals.

5. The fuel cell of claim 1, further comprising a protecting circuit connected to the steady state load, stopping the supply of electrical power from the fuel cell device when the fuel cell device receives an influence of at least one of a voltage-drop or a surge.

6. The fuel cell of claim 1, wherein the load adjusting controller increases said value of said drive load step by step, by varying the amount of change of said drive load in accordance with a numerical step sequence or by varying the amount of change of said drive load in accordance with an input.

7. The fuel cell of claim 1, wherein the steady state load is a mobile electronic device.

8. The fuel cell of claim 1, wherein the steady state load is a personal computer.

9. The fuel cell device according to claim 1, wherein said load adjusting controller limits an increase of said value of said drive load, in a case where an output current of said fuel cell is equal to or greater than a specified current value.

10. The fuel cell device according to claim 1, wherein said load adjusting controller limits an increase of said value of said drive load, where an output voltage of said fuel cell is equal to or lower than a predetermined voltage value.

11. A controller of fuel cell device supplying electrical power to a steady state load connected when said fuel cell is in a steady state, comprising
a load switching controller connecting any of the steady state load and a drive load to said fuel cell, and
a load adjusting controller adjusting a value of said drive load, wherein
said load switching controller connects said drive load to said fuel cell at the time of driving said fuel cell,
said load adjusting controller increases said value of said drive load step by step, and
said load switching controller switches, when said value of said drive load reaches a predetermined value, the load of said fuel cell to said steady state load from said drive load.

12. A control method of a fuel cell device including a steady state load and a drive load to supply electrical power to said steady state load from said fuel cell when said fuel cell is in a steady state, comprising
connecting said drive load to said fuel cell at a time of driving said fuel cell,
increasing step by step a value of said connected drive load, and
connecting the load of said fuel cell to said steady state load from said drive load when said value of said drive load reaches a predetermined value.

13. A computer-readable medium storing a control program for a fuel cell device including a steady state load and a drive load to supply electrical power to said steady state load from said fuel cell when said fuel cell is in a steady state, wherein said control program causes said fuel cell device to execute:
connecting said drive load to said fuel cell at a time of driving said fuel cell,
increasing step by step a value of said connected drive load, and
connecting the load of said fuel cell to said steady state load from said drive load when said value of said drive load reaches a predetermined value.

14. A control method of a fuel cell device including a drive load and a steady state load, comprising:
supplying fuel to a fuel cell, in an initial state;
connecting the drive load to the fuel cell at a predetermined time, and increasing a value of the drive load incrementally, with each incremental increase of the value of the drive load causing the fuel supply to be momentarily reduced and stabilized thereafter, in a drive state; and
switching to the steady state load from the drive load, when in the drive state a stable output power is achieved,
wherein the drive state is repeated until the stable output power is achieved.

15. A fuel cell device supplying fuel cell power to a target load, comprising:
a drive load controller adjusting a variable load of the drive load until the variable load reaches a predetermined value; and
a switch switching the fuel cell power from the drive load to the target load when the predetermined value is reached.

16. The fuel cell device of claim 15, wherein the drive load comprises:
a drive load circuit receiving a drive signal from the drive load controller to increase the variable load variably, and thereby allow fuel cell power to flow in the drive load circuit.

17. The fuel cell device of claim 15, wherein the switch comprises:
a first voltage and a second voltage,
wherein the fuel cell power is not supplied to the drive load or the target load when both of the first voltage and the second voltage is set to a predetermined low voltage, and the fuel cell power flows to one of the drive load or the target load when one of the first voltage and second voltage is set to a predetermined high voltage.

18. A fuel cell device supplying fuel cell power to a target load, comprising:
a drive load being varied after fuel cell power starts flowing; and
a switch switching the fuel cell power from the variable load to the target load when the variable load reaches a predetermined value.

19. A fuel cell device, comprising:
a fuel cell supplying power;
a variable drive load connectable to the fuel cell and the load being varied after the power starts flowing; and
a switch switching the power from the variable drive load to a target load when the variable load reaches a predetermined value.

20. A fuel cell control method, comprising:
varying a drive load after fuel cell power starts flowing; and
switching the fuel cell power from the drive load to a target load when the drive load reaches a predetermined value.

21. A method of claim 20, wherein a constant ratio between current or voltage is maintained during varying of the drive load.

22. A method of claim 20, wherein an adjustment in the drive load is by a first step size in an initial period, by a second step size larger than the first step size in an intermediate period, and by a third step size smaller than the second step size in a later period.

23. A method as recited in claim 20, wherein the drive load is decreased when a measured power is less than a target power and the power load is increased when the measured power is greater than the target power.

24. A fuel cell control method, comprising:
determining that a power output of the fuel cell has reached an initial state;
connecting a drive load to the fuel cell and varying the power output to the drive load;
decrementing a present number of times of repetition;
calculating the power output of the fuel cell from a measured voltage and a measured current of the fuel cell;
determining whether the measured voltage is equal to or greater than a voltage setting value;
determining whether the present number of times of repetition is equal to zero if the determined measured voltage is less than the voltage setting value,
wherein
decrementing a setting value by a variable voltage,
determining whether the setting value is greater than or equal to a predetermined lower limit voltage,
setting the present number of times of repetition to a specified number of repetitions if the setting value is greater than or equal to the predetermined lower limit voltage,
separating the drive load if the setting value is less than the predetermined lower limit voltage,
executing a fuel cell stop when the setting value is less than the predetermined lower limit voltage;
determining whether the measured current is greater than an upper limit value of a predetermined current if the determined measured voltage is equal to or greater than the voltage setting value;
decrementing the present number of times of repetition waiting for increase of the drive load power if the measured current is less than the upper limit value of the predetermined current;
increasing the drive load power when the present number of times of repetition waiting for increase of the drive load power is equal to zero, else returning to the decrementing the present number of times of repetition;
determining whether the drive load power is greater than a predetermined upper limit value power; and
switching the fuel cell from the drive load to a target load when the drive load power is greater than a predetermined upper limit power.
